(19) United States
(12) Patent Application Publication
(10) Pub. No.: US 2024/0286159 A1
(43) Pub. Date: Aug. 29, 2024

(54) TRIGGER DISPENSING DEVICE

(71) Applicant: GUALA DISPENSING S.P.A., Alessandria (IT)

(72) Inventor: Riccardo ALLUIGI, Alessandria (IT)

(21) Appl. No.: 18/572,286

(22) PCT Filed: Jul. 22, 2022
(86) PCT No.: PCT/IB2022/056796

§ 371 Date: Dec. 20, 2023

(30) Foreign Application Priority Data
Sep. 20, 2021 (IT) 102021000024077

(51) Int. Cl. B05B 11/10; B05B 11/00

(52) U.S. Cl. CPC B05B 11/1057; B05B 11/0029; B05B 11/1059

(57) ABSTRACT

A trigger dispensing head for a dispensing device is provided. The trigger dispensing head has a frame, a manually operable trigger, a piston chamber, a piston, a dispensing duct, a suction duct, pre-compression valves, suction valves, a locking member and a nozzle having a gripping wall equipped with an actuation compartment and an interference element. The nozzle is movable between an opening position, in which the locking member is freely movable in the actuation compartment, and a closing position, in which the locking member engages the interference element, preventing an actuation stroke of the manually operable trigger.

### FIELD OF THE INVENTION

The present invention is in the field of trigger dispensing devices for liquid products, generally used for household hygiene, air freshening, ironing clothing, personal care, plant care, animal care, and many other uses. These devices are enormously popular; in fact, several hundred million of them are produced each year.

In particular, the subject of the present invention is a trigger dispensing head applicable to a bottle, equipped with a dispensing nozzle that may be moved between an opening and a closing position, in which the trigger actuation stroke is allowed and prevented, respectively.

In the field of trigger dispensing devices, there is a particular need to prevent unintentional trigger actuation, for example during transport, such as, for example, illustrated in the International Application WO-A1-2019116115 in the name of the Applicant.

In addition, the industry is driven by a constant reduction in the number of components and their size, designing parts that are multifunctional, simple to produce, cost-effective, and intuitive to use. Further examples of dispensing devices are described in documents US-B2-10549296, US-B2-11213842 and JP-A-H10146545.

### OBJECT OF THE INVENTION

The object of the present invention is to meet the needs of the industry and to overcome the drawbacks of the solutions of the prior art. Such object is achieved by a dispensing head according to claim 1 and the dispensing device according to claim 20. Dependent claims identify additional advantageous embodiments.

### BRIEF DESCRIPTION OF THE DRAWINGS

The features and advantages of the dispensing head according to the present invention will be apparent from the description below-mentioned, given by way of exemplary and non-limiting title in accordance with the figures in the appended tables, wherein:

FIG. 1 depicts a trigger dispensing device according to one embodiment of the present invention;

FIG. 2 represents a cut-away view of a trigger dispensing head of the dispensing device in FIG. 1;

FIG. 3 illustrates an enlargement of a region in FIG. 2 drawing attention to the nozzle of the dispensing head, positioned in the closing position;

FIG. 4 represents the nozzle of the dispensing head positioned in the opening position;

FIG. 5 shows a cut-away view of the dispensing head in FIG. 1 along a plane transverse to the nozzle axis;

FIG. 6 illustrates the nozzle of the dispensing head according to a preferred embodiment;

FIG. 7 shows a front view of the nozzle in FIG. 6;

FIG. 8 represents a cut-away view along the plane A-A of the nozzle in FIG. 7;

FIG. 9 represents a cut-away view along the plane B-B of the nozzle in FIG. 7;

FIG. 10 illustrates a dispensing head trigger of the present invention, according to a preferred embodiment;

FIG. 11 shows a front view of the trigger in FIG. 10;

FIG. 12 represents a cut-away view along the plane C-C of the trigger in FIG. 11.

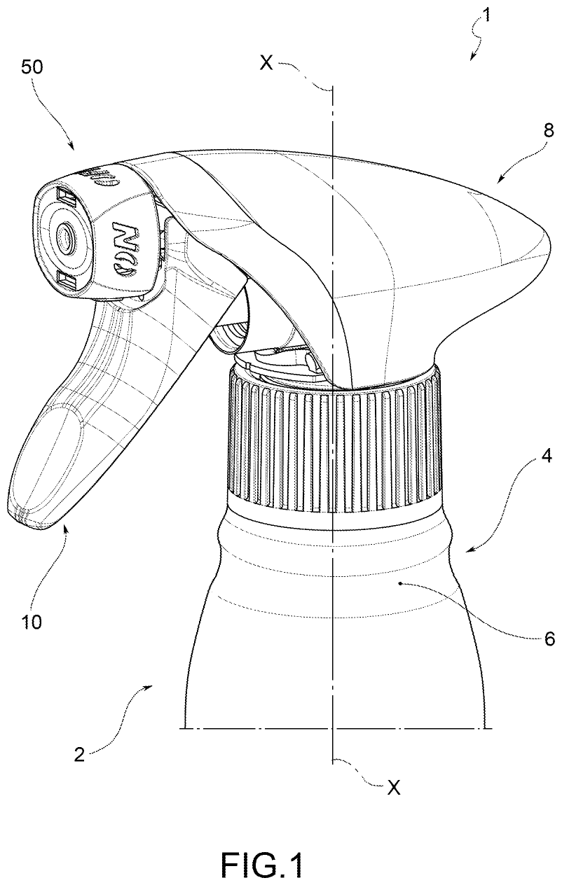

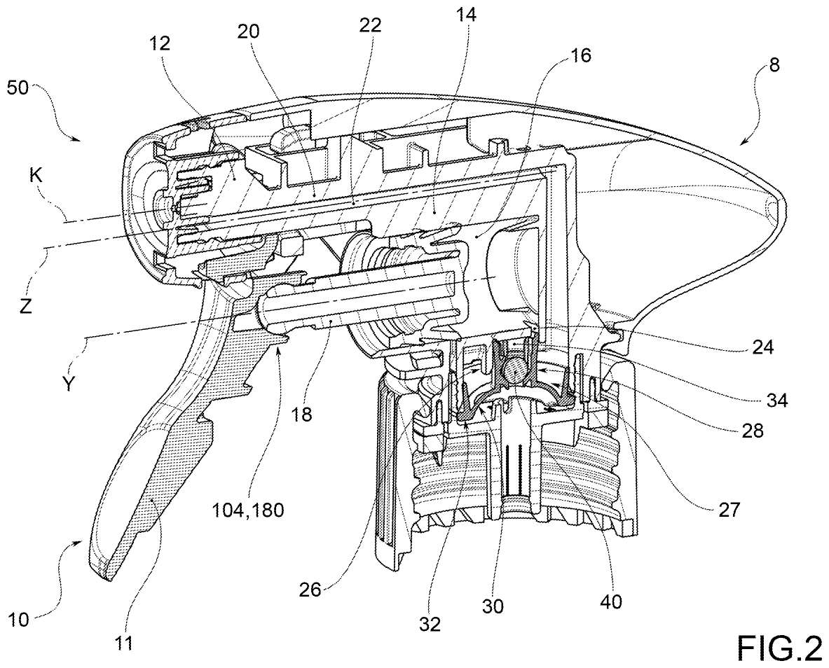

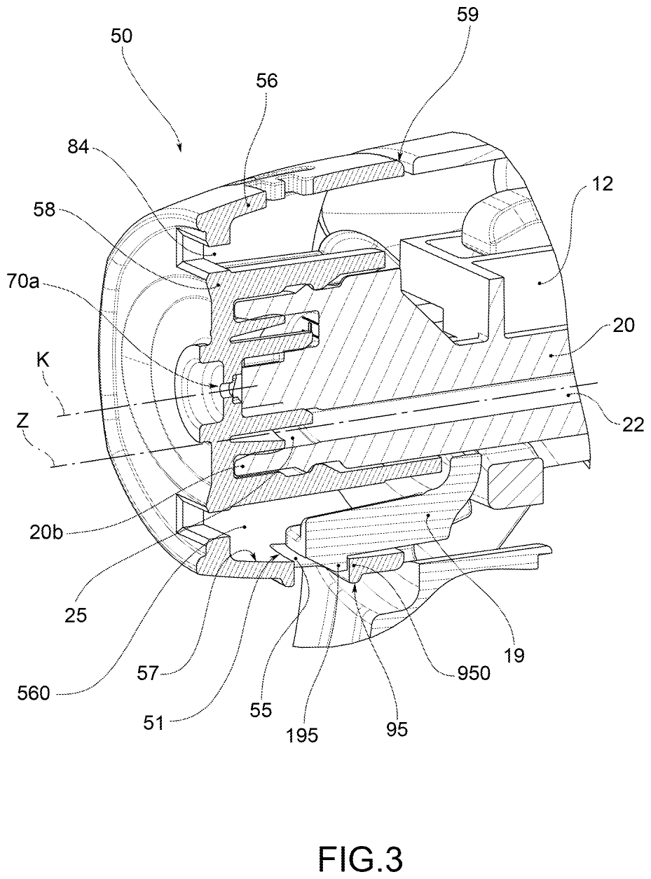

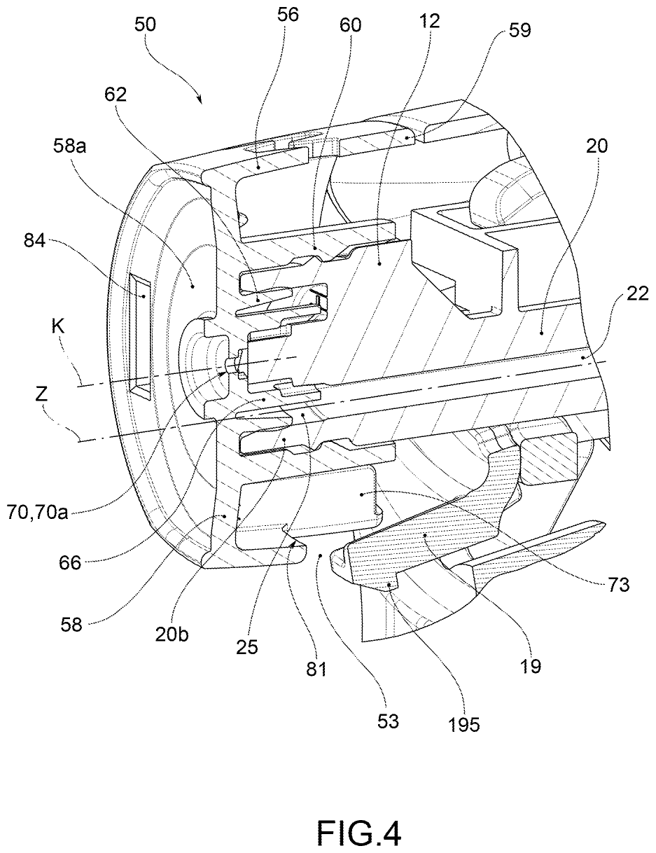

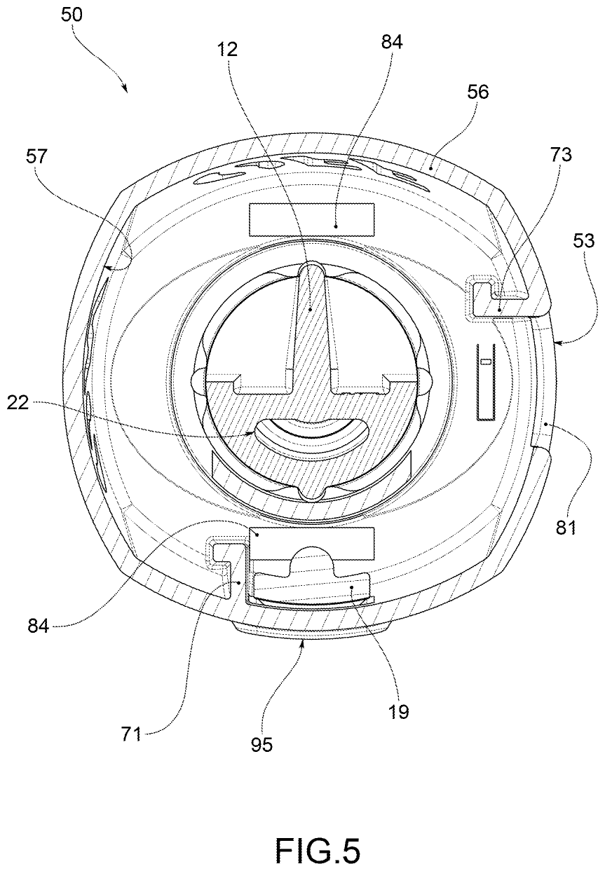

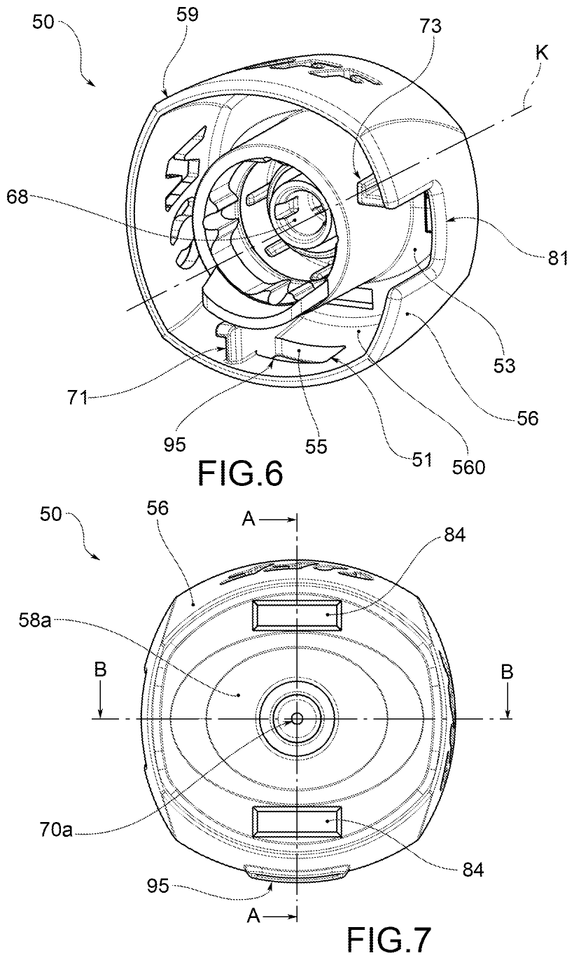

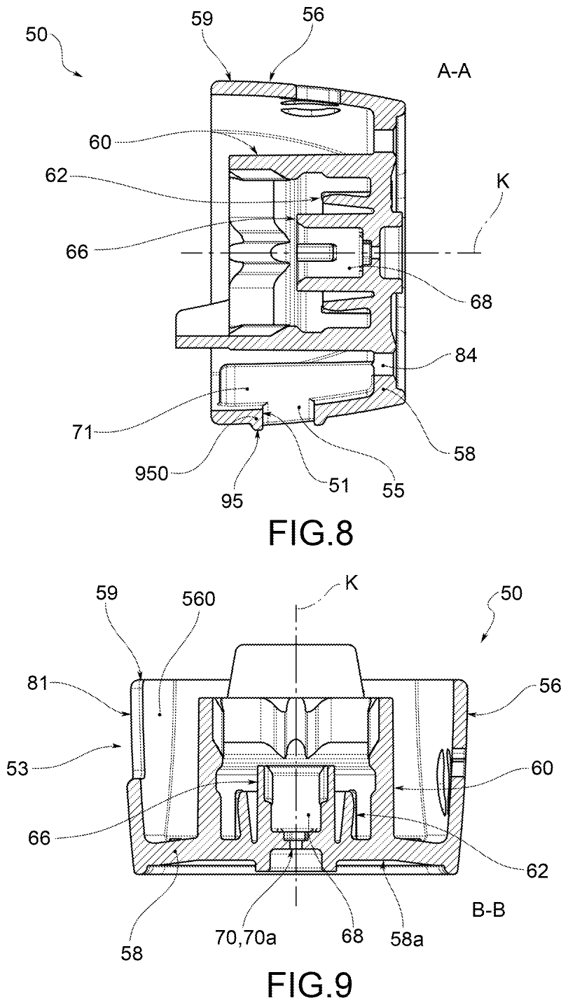

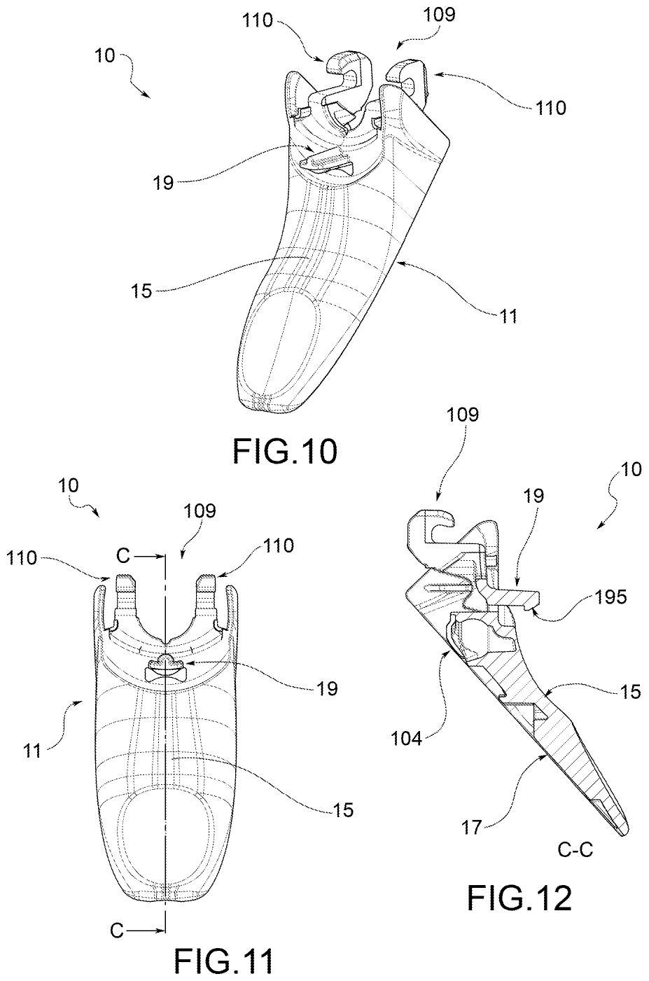

### DETAILED DESCRIPTION OF AN EMBODIMENT

With reference to the figures in the attached drawings, a trigger dispensing device according to the present invention is collectively referred to as 1. The dispensing device 1 comprising a bottle 2 and a dispensing head 8, removably or irremovably applicable to a neck 4 of the bottle 2, for example, via a threaded connection or bayonet connection. Preferably, the neck 4 consists of an annular neck wall 6 extending along a central neck axis X to connect with the dispensing head 8.

According to the present invention, the dispensing head 8 comprises a frame 12 for supporting the components, preferably made in one single piece, for example of plastics material, by injection molding.

The frame 12 supports a first annular wall 14 extending along a piston axis Y, incident to the neck axis X, for example orthogonally; the first wall 14 delimits a piston chamber 16, in which a piston 18 is sealingly slidable. Preferably, the frame 12 comprises the first wall 14.

The frame 12 further supports a second annular wall 20 extending along a dispensing axis Z, preferably parallel to the piston axis Y; the second wall 20 delimits a dispensing duct 22, suitable to be placed in communication with the piston chamber 16 and ending with a dispensing end 25. Preferably, the frame 12 comprises the second wall 20.

The piston chamber 16 is in communication with a main duct 24 for the inlet of the product suctioned into the piston chamber 16 and for the outlet of the product to be dispensed from the piston chamber 16 towards the dispensing duct 22.

The frame 12 also supports an annular main wall 26, protruding from the second wall 14, preferably parallel to the neck axis X, which has a main inner side surface provided with a plurality of recesses forming passages for the product being dispensed.

Preferably, the frame 12 comprises the main wall 26.

The head 8 further comprises suction valve means configured to operate between a closing position, assumed in the dispensing configuration of the head 8, in which the suction and the passage of the product towards the compartment of the bottle 2 are prevented, and an opening position of the head 8, assumed in the suction configuration, in which the suction is allowed.

The head 8 comprises pre-compression valve means configured to operate between the main duct 24 and the dispensing duct 22 and suitable, in a dispensing step, to pass the product from the piston chamber 16 towards the dispensing duct 22 only when the pressure of the product in the piston chamber 16 exceeds a predefined threshold value. In addition, in a suction step, the pre-compression valve means are suitable to prevent the passage of air from the dispensing duct 22 to the piston chamber 16.

Said pre-compression valve means comprise a valve assembly 27 comprising a tang 28, an elastically deformable membrane 30, and an engagement portion 32. Preferably, the valve assembly 27 is made in one single piece of plastics material, for example by injection molding.

The tang 28 has a tang portion slidable on the main wall 26. In a resting configuration, the tang 28 is in contact with a sealing band of the main wall 26. During an initial sub-step of the dispensing step, wherein, by actuating the trigger, the pressure of the product in the piston chamber 16 increases, the tang 28 slides, while maintaining contact with the sealing band, and the product does not pass towards the dispensing duct 22. During a second sub-step of the dispensing step, at the beginning of which the product pressure is greater than or equal to a predefined threshold pressure, the tang 28 slides along the main inner side surface of the main wall 26 past the sealing band, so as to allow the product to pass outside the tang, towards the dispensing duct 22.

Moreover, the tang 28 is penetrated by a suction duct 34 suitable to place the main duct 24 in communication with the compartment of the bottle 2. Along the suction duct 34, said suction valve means comprise a ball 40, movable in the suction duct 34, which occludes the suction duct 34 in the closing position and at least partially frees the dispensing duct 34 in the opening position.

Additional structural and functional details of the pre-compression and suction valve means are illustrated in the International Application WO-A1-2014/013352, in the name of the Applicant, the teaching of which is incorporated herein.

The dispensing head 8 comprises a manually operable trigger 10 operatively connected to the piston 18 to move it between a rest position and a limit stop position.

Preferably, the trigger 10 comprises a lever 11 having a front surface 15 suitable to support a user's fingers to actuate the dispensing head, and a back surface 17 opposite to the front surface 15, for instance facing the piston 18.

The trigger 10 comprises a trigger engagement portion 104 to connect with the piston 18. For example, the trigger engagement portion 104 is hinged to a piston engagement portion 180 of the piston 18, forming a shape or interlocking coupling.

The trigger 10 also comprises frame connection members 109, for example a pair of hooks 110 engageable in rotation to the frame 12, which enable the movement of the trigger 10, and in particular of the lever 11.

The dispensing head 8 further comprises a nozzle 50, applied to an annular end section 20b of the second wall 20, which defines the dispensing end 25 of the dispensing duct 22. The nozzle has a nozzle axis K, preferably parallel to the dispensing axis Z.

The nozzle 50, preferably made in one single piece, for example of plastics material, comprises a base 58, orthogonal to the nozzle axis K, from which an annular gripping wall 56 extends, coaxial to the nozzle axis K.

The gripping wall 56 is shaped to be maneuvered, preferably rotated, about the nozzle axis K, for example manually by a user, between an opening position and a closing position of the nozzle 50, which is discussed below.

Preferably, the nozzle 50 comprises an annular connection wall 60, placed radially internally to the gripping wall 56, projecting axially from the base 58, suitable to form a snap-connection on an external surface of the end section 20b.

In addition, the nozzle 50 comprises an annular sealing lip 62, placed radially internally to the connection wall 60, protruding axially from the base 58, suitable to form a seal with an inner surface of the end section 20b.

According to the invention, the nozzle 50 is applied to the end section 20b in a movable manner, for instance rotatable with respect to the nozzle axis K, between an opening position, in which the trigger actuation stroke 10 is allowed, and a closing position, in which trigger actuation stroke 10 is prevented.

Preferably, moreover, in the closing position dispensing of the product is also prevented. In particular, the nozzle 50 comprises an annular conveying wall 66, positioned radially internally to the sealing lip 62, protruding axially from the base 58, which delimits a nozzle chamber 68 in communication with the dispensing duct 22 in the opening position of the nozzle 50.

The base 58 of the nozzle 50 has a nozzle passage 70 through the thickness thereof, coaxial to the nozzle axis K, which places the nozzle chamber 68 in communication with the exterior, emerging, via an outer port 70a, towards an outer face 58a of the base 58.

Preferably, however, in the closing position of the nozzle 50, the nozzle chamber 68 is fluidly separated from the dispensing duct 22, preventing the product from dispensing.

Preferably, the nozzle 50 comprises at least one connection window 84 open on an outer face 58a of the base 58, being engageable, for example, by snapping, to a foamer of the dispensing head 8.

The dispensing head 8 further comprises a locking member 19 positioned on the trigger 10.

Preferably, the locking member 19 has a hook shape made in one piece with the trigger 10, protruding therefrom, for instance protruding from the front surface 15 of the lever 11.

Preferably, the locking member 19 is positioned along the lever 11 between the piston axis Y and the nozzle axis K.

In one embodiment, the gripping wall 56 annularly defines a nozzle housing 560, within which the locking member 19 houses the nozzle 50 in the closing position.

In addition, in the opening position of the nozzle 50 and with the trigger 10 stopped, i.e., when the trigger 10 is not actuated and does not bias the piston 18 from its rest position, the locking member 19 is preferably arranged in the nozzle housing 560.

Preferably, an annular inner surface 57 of the gripping wall 56 annularly delimits said nozzle housing 560, and the locking member 19 slides in contact with said inner surface 57 during the positioning of the nozzle 50 from the opening position to the closing position and vice versa.

According to the invention, the nozzle 50 also comprises an actuation compartment 53 positioned on the gripping wall 56 and suitable to accommodate the locking member 19 in the opening position of the nozzle 50.

Preferably the actuation compartment 53 is a recess in the gripping wall 56.

In one embodiment, the actuation compartment 53 passes radially through the thickness in the gripping wall 56, being delimited perimetrically by an actuation compartment edge 81 of the nozzle 50, i.e., open on the inner surface 57.

Specifically, the locking member 19 is freely movable in said actuation compartment 53 in the opening position of the nozzle 50, allowing the actuation stroke of the trigger 10.

Preferably, the actuation compartment 53 is axially open at a free end 59 of the gripping wall 56, i.e., it is accessible from said free end 59 along the nozzle axis K.

Preferably, the locking member 19 is movable along an imaginary plane passing through the nozzle axis K, for example by making a rotation during the actuation stroke of the trigger 10.

In a preferred embodiment, during the actuation stroke of the trigger 10, the locking member 19 passes through the actuation compartment 53 in a radial direction relative to the nozzle axis 50.

Preferably, during the actuation stroke of the trigger 10, the locking member 19 passes through the actuation compartment 53 in the axial direction.

In other words, in the opening position of the nozzle 50, the locking member 19 is free to pass radially and/or axially through the actuation compartment 53, following the movement made by the trigger 10, for example, the lever 11, during its actuation stroke.

According to the invention, the nozzle 50 further comprises an interference element 95 positioned on the gripping wall 56, for example on its inner surface 57, and the locking member 19 engages the interference element 95 in the closing position of the nozzle 50 in such a way as to prevent the actuation stroke of the trigger 10.

Preferably, the locking member 19 is provided with an end tooth 195, suitable for snap-engaging the interference element 95.

In one embodiment, the nozzle 50 comprises a locking compartment 55, located on the gripping wall 56 and suitable to at least partially accommodate the locking member 19 in the closing position of the nozzle 50.

Preferably, the locking compartment 55 is a recess in the gripping wall 56.

In one embodiment, the locking compartment 55 radially passes through the thickness of the gripping wall 56, being delimited perimetrically by a locking compartment edge 51 of the nozzle 50, and being open on the inner surface 57.

Preferably, the locking compartment edge 51 accommodates at least partially the interference element 95 in the radial direction.

In a preferred embodiment, a resistant portion 950 of said locking compartment edge 51, for example, a sharp edge thereof positioned on the inner surface 57, forms the interference element 95 that is engaged by the locking member 19 in the closing position of the nozzle 50.

Preferably, moreover, the nozzle comprises an auxiliary groove, made in the gripping wall and open on the inner surface between the actuation compartment and the locking compartment. Preferably, the locking member 19 is movable in said auxiliary groove, preferably is guided, during the positioning of the nozzle from the opening position to the closing position and vice versa.

In one embodiment, the locking member 19 has a T-shaped section along a section plane transverse to the gripping wall 56, i.e., transverse to the nozzle axis K.

The nozzle 50 comprises at least one backing wall 71, 73 radially protruding internally from the gripping wall 56, configured to form a limit stop for the locking member 19 upon reaching the closing position and/or the opening position.

In one embodiment, the nozzle 50 comprises a first backing wall 73 protruding radially internally from the gripping wall 56, i.e., from the inner surface 57, which forms a limit stop for the locking member 19 upon reaching the opening position.

Preferably, the first backing wall 73 is positioned at a portion of the actuation window edge 81, for example on one side thereof, oriented along the nozzle axis K.

In one embodiment, the nozzle 50 is provided with a second backing wall 71 radially protruding internally from the gripping wall 56, i.e., from the inner surface 57, configured to form a limit stop for the locking member 19 when the closing position is reached.

Preferably, said second backing wall 71 is positioned at a portion of the locking compartment edge 51, such as on one side thereof, oriented along the nozzle axis K.

In other words, the first backing wall 73 and the second backing wall 71 prevent the nozzle 50 from rotating further in a certain direction, for example, clockwise and counterclockwise, respectively, suggesting to the user the effective positioning of the locking member 19.

Innovatively, the dispensing head described above, provided with the nozzle and the locking member, meets the needs of the industry, as it forms a locking system that prevents the actuation stroke of the trigger in a simple and intuitive way, comprising a limited number of integrated and multifunctional components.

It is understood that a person skilled in the art, in order to meet contingent needs, could make modifications to the dispensing head described above, all of which are contained within the scope of protection as defined by the following claims.

What is claimed is:

1. A trigger dispensing head for a dispensing device, comprising:
a frame applicable to a bottle of the dispensing device;
a manually operable trigger;
a piston chamber supported by the frame and a piston sealingly slidable in the piston chamber along a piston axis through actuation by the manually operable trigger;
a dispensing duct, ending with a dispensing end, in communication with the piston chamber to take a product being dispensed from the piston chamber towards an external environment;
a suction duct in communication with the piston chamber to take the product being suctioned from the bottle to the piston chamber;
suction valve means adapted to operate between the piston chamber and the suction duct to allow a passage of the product being suctioned from the bottle to the piston chamber during a suction step and to prevent the product from returning from the piston chamber to the bottle during a dispensing step;
a locking member positioned on the manually operable trigger; and
a nozzle engaged to the frame having a nozzle axis, comprising:
a base positioned at the dispensing end, provided with a nozzle passageway and an outer port;
an annular gripping wall extending from the base;
an actuation compartment located on the annular gripping wall, suitable for receiving the locking member; and
an interference element positioned on the annular gripping wall;
wherein the nozzle is positionable in a closing position, in which the locking member engages the interference element 9 preventing an actuation stroke of the manually operable trigger, and in an opening position, in which the locking member is freely movable in the actuation compartment allowing the actuation stroke of the manually operable trigger; and
wherein the nozzle comprises at least one backing wall radially protruding internally from the annular gripping wall, configured to form a limit stop for the locking member upon reaching the closing position and/or the opening position.

2. The trigger dispensing head of claim 1, wherein the manually operable trigger comprises a lever having a front surface suitable for supporting a user's fingers, and a rear surface opposite to the front surface, and wherein the locking member protrudes from the front surface.

3. The trigger dispensing head of claim 1, wherein the locking member is made in one piece with the manually operable trigger.

4. The trigger dispensing head of claim 1, wherein the locking member has a T-shaped section along a section plane transverse to the annular gripping wall.

5. The trigger dispensing head of claim 1, wherein, in the opening position of the nozzle, the locking member is freely movable along an imaginary plane passing through the nozzle axis.

6. The trigger dispensing head of claim 1, wherein the locking member comprises an end tooth suitable for snap-engaging the interference element.

7. The trigger dispensing head of claim 1, wherein the locking member is positioned between the piston axis and the nozzle axis.

8. The trigger dispensing head of claim 1, wherein the nozzle is rotatable about the nozzle axis between the closing position and the opening position.

9. The trigger dispensing head of claim 8, wherein the annular gripping wall comprises an inner annular surface, wherein the locking member slides in contact with said inner surface when positioning the nozzle from the opening position to the closing position and vice versa.

10. The trigger dispensing head of claim 1, wherein the annular gripping wall annularly defines a nozzle housing, and wherein the locking member is housed in said nozzle housing in the closing position of the nozzle.

11. The trigger dispensing head of claim 1, wherein the annular gripping wall has comprises a free end opposite to the base, and wherein the actuation compartment is open at the free end.

12. The trigger dispensing head of claim 1, wherein the actuation compartment passes radially through the annular gripping wall.

13. The trigger dispensing head of claim 1, wherein the nozzle is provided with an actuation compartment edge delimiting the actuation compartment, and wherein a first backing wall is positioned on a portion of said actuation compartment edge.

14. The trigger dispensing head of claim 1, wherein the nozzle comprises a locking compartment positioned on the annular gripping wall, suitable for accommodating at least partially the locking member in the closing position of the nozzle.

15. The trigger dispensing head of claim 14, wherein the nozzle is provided with a locking compartment edge delimiting, at least partially, the locking compartment, and wherein the interference element is positioned on a portion of said locking compartment edge.

16. The trigger dispensing head of claim 14, wherein the nozzle is provided with a locking compartment edge delimiting, at least partially, the locking compartment, and wherein a portion of said locking compartment edge constitutes the interference element.

17. The trigger dispensing head of claim 15, wherein a second backing wall is positioned on a portion of said locking compartment edge.

18. The trigger dispensing head of claim 14, wherein the nozzle comprises an auxiliary groove formed in the annular gripping wall between the actuation compartment and the locking compartment, and wherein the locking member is movable in said auxiliary groove when positioning the nozzle from the opening position to the closing position and vice versa.

19. The trigger dispensing head of claim 1, wherein the base of the nozzle has at least one connection window engageable by a foamer of the trigger dispensing head.

20. A dispensing device comprising:
a bottle for containing a product to be dispensed; and
the trigger dispensing head of claim 1 applied to the bottle.
